(19) United States
(12) Patent Application Publication
(10) Pub. No.: US 2013/0249954 A1
(43) Pub. Date: Sep. 26, 2013

(54) LIQUID CRYSTAL DISPLAY

(71) Applicants: Chun-Chieh Chiu, Taoyuan County (TW); Tzu-Chiang Shen, Taoyuan County (TW); Hsiang-Tan Lin, Keelung City (TW); Shih-Chieh Lin, New Taipei City (TW)

(72) Inventors: Chun-Chieh Chiu, Taoyuan County (TW); Tzu-Chiang Shen, Taoyuan County (TW); Hsiang-Tan Lin, Keelung City (TW); Shih-Chieh Lin, New Taipei City (TW)

(73) Assignee: CHUNGHWA PICTURE TUBES, LTD., Taoyuan (TW)

(21) Appl. No.: 13/480,480

(22) Filed: May 25, 2012

(30) Foreign Application Priority Data
Mar. 22, 2012 (TW) 101109880

(51) Int. Cl. G09G 3/36

(52) U.S. Cl. 345/690; 345/102

(57) ABSTRACT

A liquid crystal display having a back light module and a control unit is provided. The control unit controls the back light module to adjust turn-on time and light luminous intensity of a back light source according to the brightness difference of a left eye image and a right eye image, so as to balance the brightness of the left eye image and the right eye image and improve cross talk problem.

### CROSS-REFERENCE TO RELATED APPLICATION

This application claims the priority benefit of Taiwan application serial no. 101109880, filed on Mar. 22, 2012. The entirety of the above-mentioned patent application is hereby incorporated by reference herein and made a part of this specification.

### BACKGROUND OF THE INVENTION

1. Field of the Invention

The present invention relates to a liquid crystal display and particularly relates to a liquid crystal display capable of balancing the brightness of the left eye and the right eye and reducing crosstalk.

2. Description of Related Art

FIG. 1 is a schematic view of a conventional three-dimensional display system. The three-dimensional display system 100 includes a liquid crystal display 102 (which includes a back light module and a polarizer) and a liquid crystal polarization panel 104, wherein the liquid crystal polarization panel 104 is disposed in front of the liquid crystal display 102. The liquid crystal display 102 can emit an image having a specific polarization angle (45 degrees, for example), and the liquid crystal polarization panel 104 can adjust the polarization angle (to 135 degrees, for example) of the image emitted by the liquid crystal display 102 according to a polarization control signal. The liquid crystal display 102 and the liquid crystal polarization panel 104 continuously provide left-eye and right-eye images having different polarization angles (for example, the polarization angle of the left-eye image is 135 degrees and the polarization angle of the right-eye image is 45 degrees). The viewer can see the three-dimensional effect by wearing a pair of polarizing glasses 106 (which allows the left eye to receive the image with the polarization angle of 135 degrees only and allow the right eye to receive the image with the polarization angle of 45 degrees only).

FIG. 2 is a diagram illustrating the timing that the conventional three-dimensional display system controls a back light source. As shown in FIG. 2, the back light control method of the current liquid crystal display 102 is to turn on the back light during the vertical blanking internal (VBI); that is to say, the back light is turned off during the display data transmission period D1. The liquid crystal polarization panel 104 begins transition to change the polarization direction of the light that passes through the liquid crystal polarization panel 104 only after receiving the polarization control signal, wherein the polarization control signal drives the liquid crystal polarization panel 104 with different levels, so as to avoid liquid crystal polarization. The liquid crystal transition characteristic in the liquid crystal polarization panel 104 is similar to a resistance capacitance (RC) charge status; that is, the liquid crystal would slowly rotate for some time before reaching the status of complete transition. Therefore, before the transition is completed, the polarization angle of the light does not reach the optimal angle and causes crosstalk phenomenon in the left-eye and right-eye images. In addition, the speed that the liquid crystal returns to the original status is faster than the speed that the liquid crystal is driven by voltage to transit. Therefore, the problem that the polarization angle of light does not reach the optimal angle does not occur on the left-eye image, and this difference causes the viewer to feel the unbalanced brightness between the left-eye and the right-eye images.

### SUMMARY OF THE INVENTION

The present invention provides a liquid crystal display for balancing the brightness of a left-eye image and a right-eye image and reducing crosstalk.

A liquid crystal display is provided for alternately displaying a left-eye image and a right-eye image to display a three-dimensional image. The liquid crystal display includes a back light module and a control unit. The back light module provides a back light source. The control unit is coupled to the back light module and controls the back light module to adjust turn-on time and light luminous intensity of the back light source according to a brightness difference between the left-eye image and the right-eye image.

In an embodiment of the present invention, the control unit further uses the brighter image of the left-eye image and the right-eye image as a reference to control the back light module to delay the turn-on time and enhance the light luminous intensity of the back light source corresponding to the other image.

In an embodiment of the present invention, the back light module consumes the same power when providing the back light source for the left-eye image and the right-eye image.

In an embodiment of the present invention, the control unit further uses the darker image of the left-eye image and the right-eye image as a reference to control the back light module to reduce the light luminous intensity of the back light source corresponding to the other image.

In an embodiment of the present invention, the darker image of the left-eye image and the right-eye image requires more time for liquid crystal transition.

In an embodiment of the present invention, the control unit further controls the back light module to simultaneously adjust the turn-on time and light luminous intensity of the back light source corresponding to the left-eye image and the right-eye image.

In an embodiment of the present invention, the control unit further controls the back light module to simultaneously delay the turn-on time of the back light source corresponding to the left-eye image and the right-eye image and respectively enhance the light luminous intensity of the back light source corresponding to the left-eye image and the right-eye image according to the brightness difference between the left-eye image and the right-eye image.

In an embodiment of the present invention, the control unit further controls the back light module to simultaneously delay the turn-on time of the back light source corresponding to the left-eye image and the right-eye image and respectively reduce the light luminous intensity of the back light source corresponding to the left-eye image and the right-eye image according to the brightness difference between the left-eye image and the right-eye image.

In an embodiment of the present invention, the liquid crystal display further includes a liquid crystal display panel and a liquid crystal polarization panel. The liquid crystal display panel is coupled to the control unit and controlled by the control unit to display the left-eye image and the right-eye image. The liquid crystal polarization panel is coupled to the control unit and controlled by the control unit to adjust a polarization angle of the left-eye image and the right-eye image.

Based on the above, according to the present invention, the turn-on time and light luminous intensity of the back light source are adjusted according to the brightness difference between the left-eye image and the right-eye image, thereby balancing the brightness of the left-eye and the right-eye images and reducing crosstalk.

In order to make the aforementioned and other features and advantages of the present invention more comprehensible, exemplary embodiments accompanied with figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic view of a conventional three-dimensional display system.

FIG. 2 is a diagram illustrating the timing that the conventional three-dimensional display system controls a back light source.

FIG. 3 is a block diagram depicting a liquid crystal display according to an embodiment of the present invention.

FIG. 4 is a diagram illustrating the timing of controlling the conventional back light source.

FIG. 5 is a diagram illustrating the timing of controlling a back light source according to an embodiment of the present invention.

FIG. 6 is a diagram illustrating the timing of controlling a back light source according to another embodiment of the present invention.

### DESCRIPTION OF EMBODIMENTS

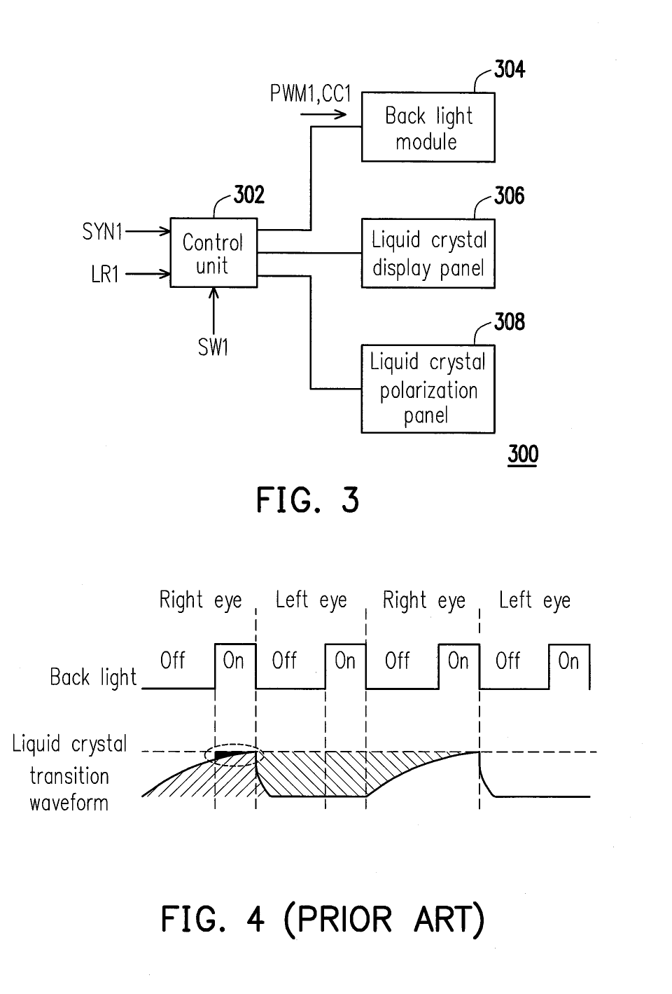

FIG. 3 is a block diagram depicting a liquid crystal display according to an embodiment of the present invention. The liquid crystal display 300 includes a control unit 302, a back light module 304, a liquid crystal display panel 306, and a liquid crystal polarization panel 308. The control unit 302 is coupled to the back light module 304, the liquid crystal display panel 306, and the liquid crystal polarization panel 308. The back light module 304 is used to provide a back light source for the liquid crystal display panel 306 to display images. The liquid crystal display panel 306 is controlled by the control unit 302 to display a left-eye image and a right-eye image. More specifically, the control unit 302 outputs a pulse width modulation signal PWM1 and a current control signal CC1 to the back light module 304 according to a synchronization signal SYN1 and a left/right-eye-image signal LR1, so as to control the back light module 304 to adjust a turn-on time and light luminous intensity of the back light source. Herein, the pulse width modulation signal PWM1 is for controlling the turn-on time of the back light source, and the current control signal CC1 is for controlling the light luminous intensity of the back light source.

Moreover, the control unit 302 further controls the liquid crystal polarization panel 308 to adjust a polarization angle of the left-eye image and the right-eye image displayed by the liquid crystal display panel 306 according to the synchronization signal SYN1 and the left/right-eye-image signal LR1, so as to allow the viewer wearing a pair of polarizing glasses to receive the left-eye image and the right-eye image alternately and see the three-dimensional effect. It is noted that, in other embodiments, the liquid crystal display 300 is not only used for three-dimensional display but can be switched to perform two-dimensional display as well. That is, the control unit 302 switches an operation mode of the liquid crystal display panel 306 and the liquid crystal polarization panel 308 according to a mode switch signal SW1, so as to switch the liquid crystal display 300 between a two-dimensional display mode and a three-dimensional display mode.

FIG. 4 is a diagram illustrating the timing of controlling the conventional back light source. FIG. 5 is a diagram illustrating the timing of controlling a back light source according to an embodiment of the present invention. The liquid crystal display 300 of FIG. 3 uses to balance the brightness of the left-eye and the right-eye images and reduce crosstalk is explained below with reference to FIGS. 4 and 5. As shown in FIG. 4, in the conventional technique, when providing back light source for the right-eye image and the left-eye image, the turn-on timing and light luminous intensity of the back light for the right-eye image is the same as the turn-on timing and light luminous intensity of the back light for the left-eye image. Because the back light source is turned on for the right-eye image before the transition of the liquid crystal in the liquid crystal polarization panel 308 is completed, a portion of the right-eye image that has a polarization angle not completely transited is received by the left eye of the viewer (the elliptic area in FIG. 4), which results in non-uniform brightness between the left-eye and the right-eye images. In addition, the problem of crosstalk also occurs in the case that the left eye of the viewer receives the right-eye image.

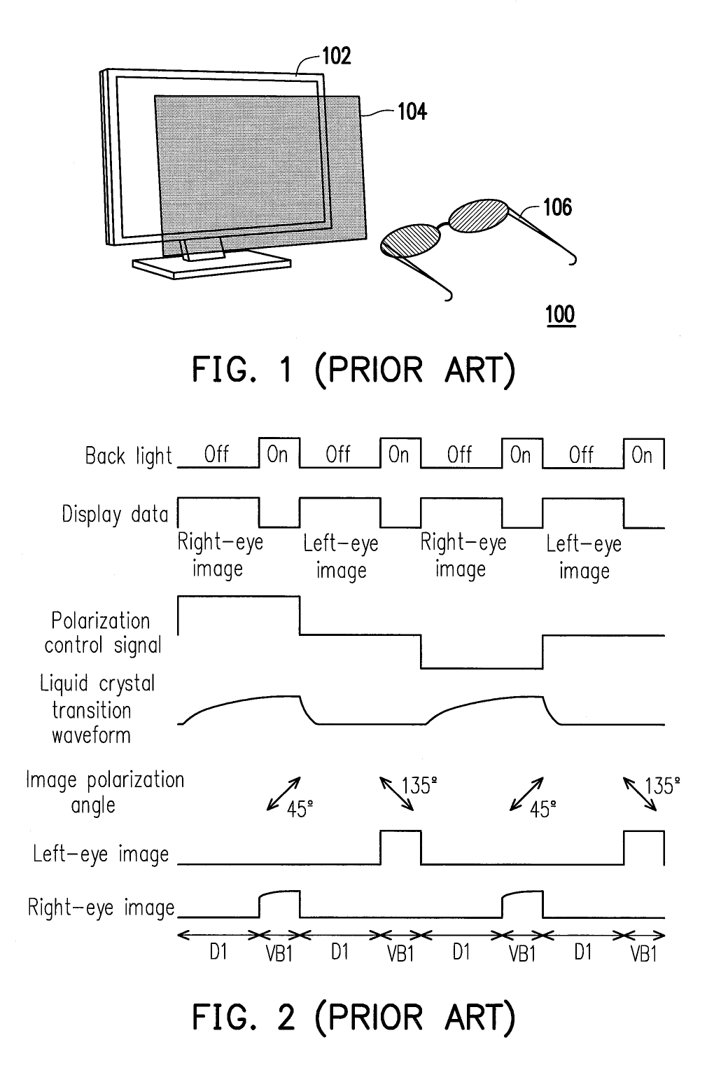

To improve the above mentioned problem, the control unit 302 in the embodiment of FIG. 1 of the present invention controls the back light module 304 to adjust the turn-on time and light luminous intensity of the back light source according to a brightness difference between the left-eye image and the right-eye image, so as to effectively improve the non-uniform brightness of the left-eye and the right-eye images and reduce crosstalk. In order to improve the decreased brightness of the right-eye image resulting from the incomplete transition of liquid crystal in the liquid crystal polarization panel 308 as illustrated in FIG. 4, the control unit 302 uses the brightness of the left-eye image as a reference and controls the back light module 304 to delay the turn-on time and enhance the light luminous intensity of the back light source corresponding to the right-eye image, as shown in FIG. 5. It can be seen from FIG. 5 that the right-eye image received by the left eye of the viewer is substantially reduced by delaying the turn-on time of the back light source corresponding to the right-eye image, and enhancement of the light luminous intensity of the back light source corresponding to the right-eye image compensates for the brightness difference between the left-eye and the right-eye images. Accordingly, since the right-eye image received by the left eye of the viewer is substantially reduced, the problem of crosstalk is improved greatly.

In the above embodiment, the right-eye image has lower brightness. However, it is noted that this embodiment is merely exemplary, and in actual application, the left-eye image may be the image that has lower brightness. Moreover, in some embodiments, the control unit 302 is configured to control the back light module 304 to consume the same power when providing the back light source for the left-eye and the right-eye images, so as to prevent the increase of power consumption. Although the effect of balancing the brightness between the left-eye and the right-eye images may slightly decrease, power energy can be saved.

Moreover, in the embodiment shown in FIG. 5, one of the left-eye image and the right-eye image, which has higher brightness, is used as a reference for controlling the back light module 304 to delay the turn-on time and enhance the light luminous intensity of the back light source corresponding to the other image, so as to balance the brightness between the left-eye and the right-eye images and improve crosstalk. However, in other embodiments of the present invention, one of the left-eye and the right eye images, which has lower brightness, is used as a reference to control the back light module 304 to reduce the light luminous intensity of the back light source corresponding to the other image, so as to balance the brightness of the left-eye and the right-eye images. It is noted that, in order to improve the problem of crosstalk simultaneously, the turn-on time of the back light source that corresponds to the image having lower brightness has to be delayed.

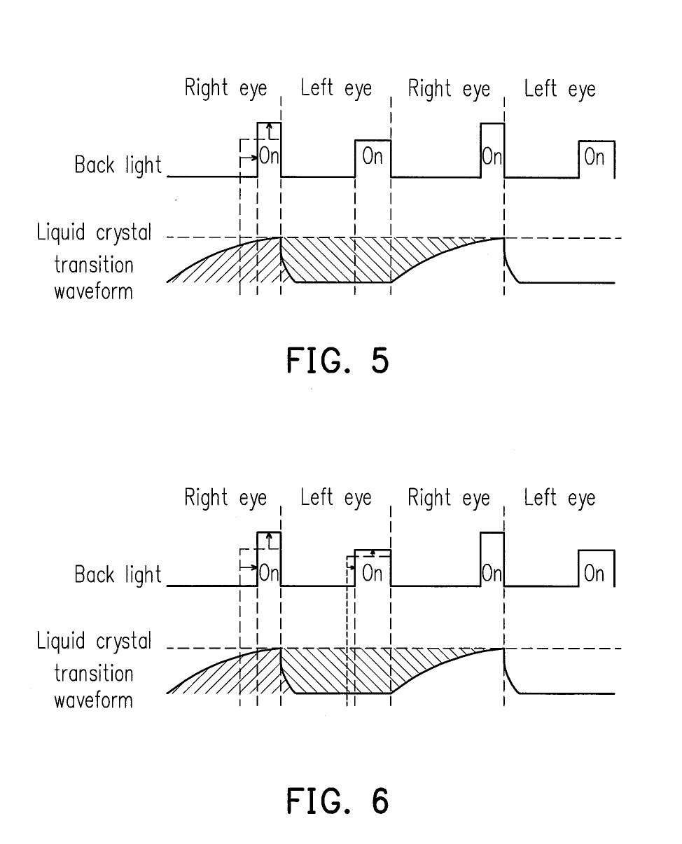

In addition, in some other embodiments, the control unit 302 controls the back light module 304 to simultaneously adjust the turn-on time and light luminous intensity of the back light source corresponding to the left-eye image and the right-eye image, so as to improve the problems of the non-uniform brightness of the left-eye and the right-eye images and crosstalk, and allow the viewer to adjust the brightness of the three-dimensional image per his/her need. For example, FIG. 6 is a diagram illustrating the timing of controlling a back light source according to another embodiment of the present invention. In this embodiment, the control unit 302 controls the back light module 304 to delay the turn-on time of the back light source corresponding to the right-eye and the left-eye images, and respectively enhance the light luminous intensity of the back light source corresponding to the left-eye and the right-eye images according to the brightness difference between the left-eye and the right-eye images, so as to improve the problems of non-uniform brightness of the left-eye and the right-eye images and crosstalk, increase the brightness of the three-dimensional image received by the viewer, and further improve the display quality.

Similarly, in another embodiment, the control unit 302 is configured to control the back light module 304 to delay the turn-on time of the back light source corresponding to the right-eye and the left-eye images, and respectively reduce the light luminous intensity of the back light source corresponding to the left-eye and the right-eye images according to the brightness difference between the left-eye and the right-eye images, so as to improve the problems of non-uniform brightness of the left-eye and the right-eye images and crosstalk, and decrease the brightness of the three-dimensional image received by the viewer at the same time.

To conclude, in the embodiments of the present invention, the turn-on time and light luminous intensity of the back light source are adjusted according to the brightness difference between the left-eye image and the right-eye image, so as to balance the brightness between the left-eye and the right-eye images and reduce crosstalk. In some other embodiments, the turn-on time of the back light source corresponding to the right-eye and the left-eye images are simultaneously delayed, and the light luminous intensity of the back light source corresponding to the left-eye and the right-eye images is respectively enhanced according to the brightness difference between the left-eye and the right-eye images, so as to increase the brightness of the three-dimensional image received by the viewer and further improve the display quality. Furthermore, in other embodiments, the turn-on time of the back light source corresponding to the right-eye and the left-eye images are simultaneously delayed, and the light luminous intensity of the back light source corresponding to the left-eye and the right-eye images is respectively reduced according to the brightness difference between the left-eye and the right-eye images, so as to reduce power consumption.

It will be apparent to those skilled in the art that various modifications and variations can be made to the above embodiments without departing from the scope or spirit of the present invention. In view of the foregoing, it is intended that the present invention covers modifications and variations provided they fall within the scope of the following claims and their equivalents.

What is claimed is:

1. A liquid crystal display, alternately displaying a left-eye image and a right-eye image to display a three-dimensional image, the liquid crystal display comprising:
a back light module, providing a back light source; and
a control unit, coupled to the back light module and controlling the back light module to adjust turn-on time and light luminous intensity of the back light source according to a brightness difference between the left-eye image and the right-eye image.

2. The liquid crystal display according to claim 1, wherein the control unit further uses the brighter image of the left-eye image and the right-eye image as a reference to control the back light module to delay the turn-on time and enhance the light luminous intensity of the back light source corresponding to the other image.

3. The liquid crystal display according to claim 2, wherein a darker image of the left-eye image and the right-eye image requires longer time for liquid crystal transition.

4. The liquid crystal display according to claim 2, wherein the back light module consumes the same power when providing the back light source for the left-eye image and the right-eye image.

5. The liquid crystal display according to claim 1, wherein the control unit further uses the darker image of the left-eye image and the right-eye image as a reference to control the back light module to reduce the light luminous intensity of the back light source corresponding to the other image.

6. The liquid crystal display according to claim 5, wherein the darker image of the left-eye image and the right-eye image requires longer time for liquid crystal transition.

7. The liquid crystal display according to claim 1, wherein the control unit further controls the back light module to simultaneously adjust the turn-on time and light luminous intensity of the back light source corresponding to the left-eye image and the right-eye image.

8. The liquid crystal display according to claim 7, wherein the control unit further controls the back light module to simultaneously delay the turn-on time of the back light source corresponding to the left-eye image and the right-eye image and respectively enhance the light luminous intensity of the back light source corresponding to the left-eye image and the right-eye image according to the brightness difference between the left-eye image and the right-eye image.

9. The liquid crystal display according to claim 7, wherein the control unit further controls the back light module to simultaneously delay the turn-on time of the back light source corresponding to the left-eye image and the right-eye image and respectively reduce the light luminous intensity of the back light source corresponding to the left-eye image and the right-eye image according the brightness difference between the left-eye image and the right-eye image.

10. The liquid crystal display according to claim 1, further comprising:
a liquid crystal display panel, coupled to the control unit and controlled by the control unit to display the left-eye image and the right-eye image; and
a liquid crystal polarization panel, coupled to the control unit and controlled by the control unit to adjust a polarization angle of the left-eye image and the right-eye image.
